(19) United States
(12) Patent Application Publication
(10) Pub. No.: US 2005/0044366 A1
(43) Pub. Date: Feb. 24, 2005

(54) Method for making databases secure

(76) Inventors: Philippe Pucheral, Valenton (FR); Luc Bouganim, Paris (FR)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/485,785

(22) PCT Filed: Aug. 7, 2002
(86) PCT No.: PCT/FR02/02824

(30) Foreign Application Priority Data
Aug. 7, 2001 (FR) 01 10552

(51) Int. Cl. H04L 9/00

(52) U.S. Cl. 713/172

(57) ABSTRACT

A secure management system for confidential database including a server having at least one computer equipped with an operating system, a database storage and a communication system, at least one host computer equipment unit including a communication system with the server and a system for constructing queries and processing results of queries, a security system to make secure the exchanges between the client equipment unit and the server, wherein the security system includes a secure hardware support connected to the client equipment unit and a microprocessor for encryption of attributes of the queries issued by the client equipment unit and decryption of responses issued by the server, a memory for recording intermediary results, a memory for recording the operating system and wherein the server records encrypted data; and a method for secure management of a database including construction of a query including at least one attribute, encrypting attributes by a calculator integral with an individual security device linked to a client equipment unit, interrogating a database containing data encrypted with a similar encryption system as those used during the preceding step, returning a response contains data corresponding to attributes of the query, and decryption of the data by the calculator of an individual security device prior to transmitting them to host equipment.

### RELATED APPLICATION

This is a §371 of International Application No. PCT/FR02/02824, with an international filing date of Aug. 7, 2002 (WO 03/014888, published Feb. 20, 2002), which is based on French Patent Application No. 01/10552, filed Aug. 7, 2001.

### FIELD OF THE INVENTION

This invention pertains to the field of secure information system and more particularly, to systems and methods for making databases secure.

### BACKGROUND

Data security has become one of the major issues of computer systems, given the proliferation of online data on the Internet (commercial sites, storing personal or professional data, remote access to corporate servers by mobile employees) and the increasing interconnection of enriched databases consulted by multiple participants (scientific, technical and medical dates). The security requirement is linked to the confidential nature of a subset of these data. The motivation of hackers attacking the data can be multiple: attempted fraud (stealing credit card numbers from commercial sites, etc.), attacks on the private life of individuals (police, political, fiscal, financial, medical investigations, etc.), commercial, diplomatic or military (Echelon system, violation of industrial or commercial secrets, violation of industrial property, etc.).

Three classes of hackers capable of attacking databases can be distinguished:

The external hacker is an intruder who infiltrates into a computer system and retrieves data files produced by the database management system (DBMS).

A natural solution is to encrypt the data to make their disk track unreadable. The external hacker will then attempt to break the encryption key. Attacks on keys are facilitated in a database context because of the large volume of data encrypted with the same key (statistical attacks). Moreover, encryption of the data is static (the keys do not change from one session to another), thus increasing the vulnerability of the database.

The user hacker is a current user of the computer system recognized by the operating system and the DBMS. He has all of the rights on a part of a divided database and can access data going beyond his rights. This hacker potentially has the same power as an external hacker and can moreover exploit his restricted rights. If the database is encrypted, he moreover has access to certain decryption keys.

The database administrator (DBA) hacks is an unscrupulous employee of the company whose function is to administer the company's computer resources or database. In this role, he has complete system rights including access to data not accessible by any other parties (e.g., logs stored in memory regarding the operations performed on the database) and can keep a close watch on the DBMS's behavior during its execution. We should note that an external hacker or user hacker who gains access to the administrative rights has the same powers as the administrator hacker.

All users must be identified and authenticated to be allowed to use a database management system (DBMS). Authentication is performed conventionally by means of a password stored in encrypted manner in a DBMS catalog. This catalog checks the correspondence between user identity and password at each new connection. The authentication procedure can be reinforced by the use of a dedicated service [Oracle Advance Security Administrator Guide, Release 8.1.7, September 2000]. This dedicated service avoids the transfer in clear of the password on the network. Also known is a variant which enables authentication of a user by different methods such as a smart card or Token Card. In addition to the authentication by means of a personal code (PIN), the hardware card element must also be recognized by the server, thereby increasing the degree of security. These mechanisms are ineffective against an attack directed against files containing the database by an external hacker (because the DBMS is then short-circuited) or against an attack carried out by a user hacker or DBA (who would have no difficulty authenticating himself).

Another solution is based on the encryption of the communications. Encryption of the communications can be used as a complement to other security mechanisms to ensure the confidentiality and integrity of the messages sent and received via a network. Their use greatly exceeds the framework of the databases. The most well known protocol in this domain is SSL (Secure Sockets Layer). C-SET (Chip-Secured Transaction) used for electronic payments on the Internet, employs smart cards for identifying and authenticating users and ensuring the encryption of message. Identification is therefore associated with the cardholder and not the terminal on which he is connected, such that the confidentiality of the encryption keys is ensured and the encryption algorithms are executed in a secure environment even if the terminal itself is not secure. Obviously, encryption of the communications does not prevent attacks on the files containing the database.

A research article [J. He, M. Wang, Cryptography and Relational Database Management Systems. Int. Database and Engineering Symposium (IDEAS), 2001] proposes an encryption solution that is more strongly integrated in the DBMS and supposedly (i) facilitates the use of the encryption by the applications and (II resists attacks by the DBA. The first objective is attained by the fact that the DBMS itself ensures the confidentiality of the encryption keys (they are stored in a secure catalog). The data are encrypted with a secret key to share them with users, with this key in turn being encrypted with the key of each user. The user never has access to the keys since the DBMS itself performs this encryption.

An elegant solution is also proposed for encrypting the database with a large number of keys generated dynamically by the DBMS, making it more difficult to implement statistical attacks for breaking the encryption key(s). Attaining the second objective (resisting attacks by the DBA) requires the implementation of the secure catalog in which the encryption keys are stored. This is established in a manner to constitute an SOE (Secure Operating Environment) in which the power of the DBA is considerably reduced. Transforming a catalog into an SOE does not bring back the integrity of the SOE DBMS. In this method, as in the Oracle method, the encryption and decryption are always performed by the server. It would thus seem illusory to ensure that the DBA could never access the data in the clear (for example, during the execution of a query or in the logs), without restricting his rights to the point that he would be unable to perform his administrative tasks. For this reason, the solution does not appear to be very convincing especially since it requires rewriting part of the core of the DBMS (the contours of which have not yet been specified).

The solutions of the prior art are not always entirely satisfactory because:

Only the encryption of the data enables resistance to attacks against the database files;

The security core (including encryption/decryption) must be managed in an SOE to resist attacks by the DBA or by a hacker who has usurped the DBA's rights:

The security core and the SOE surrounding it must be sufficiently simple so as to be self-administrable; or

A DBMS is not self-administrable.

### SUMMARY OF THE INVENTION

This invention relates to a secure management system for confidential databases including a server having at least one computer equipped with an operating system, a database storage and a communication system at least one host computer equipment unit including a communication system with the server and a system for constructing queries and processing results of queries, a security system to make secure the exchanges between the client equipment unit and the server, wherein the security system includes a secure hardware support connected to the client equipment unit and a microprocessor for encryption of attributes of the queries issued by the client equipment unit and decryption of responses issued by the server, a memory for recording intermediary results, a memory for recording the operating system and wherein the server records encrypted data.

This invention also relates to a method for secure management of a database including construction of a query including at least one attribute, encrypting attributes by a calculator integral with an individual security device linked to a client equipment unit, interrogating a data base containing data encrypted with a similar encryption system as those used during the preceding step, returning a response containing data corresponding to attributes of the query, and decryption of the data by the calculator of an individual security device prior to transmitting them to host equipment.

### BRIEF DESCRIPTION OF THE DRAWINGS

Better comprehension of the invention will be obtained from the description below of a nonlimitative example of implementation with reference to the attached drawings in which:

FIG. 1 represents a schematic view of a system according to aspects of the invention;

FIG. 2 represents a schematic view of encryption of a table;

FIG. 3 represents a diagram of the flows of information between the client equipment knit and the server;

FIG. 4 represents a diagram of the flows of information between the client equipment unit and the server in an advanced version of the invention;

FIGS. 5 and 6 represent the diagrams of execution of complex queries;

FIG. 7 represents a schematic view of the processing steps; and

FIG. 8 represents the architecture of the security card.

### DETAILED DESCRIPTION

It would therefore be advantageous to resolve these drawbacks by providing a system and a method guaranteeing a maximal degree of protection against all types of attacks (internal or external) on data available online in any type of network and managed by a traditional Database Management System (DBMS).

Advantages of the invention include the following:
to ensure confidentiality of the data managed by a DBMS,
to provide users with secure access to all data to which they legally have access from any terminal connected to the Internet,
to enable each user to share his data with other users, and
to be compatible with the software tools (DBMS) and hardware elements (smart cards) existing on the market.

The invention pertains in its broadest sense to a secure management system for confidential databases comprising a server constituted of at least one computer equipped with means for storing databases and communication means, at least one host computer equipment unit comprising communication means with the server and means for the construction of queries and the processing of the results of the queries, as well as a means to make secure the exchanges between the client equipment and the server (also referred to below under the term C-SDA for “Chip-Secured Data Access”), characterized in that the security means is constituted of a secure hardware support interfacing with the client equipment and the server and comprising a microprocessor for the encryption of the attributes of the queries issued by the client equipment and the decryption of the responses issued by the server, a random access memory for recording intermediary results, a nonwritable memory for recording the operating system and a memory for recording the user's personalization information and the server records encrypted data.

This system responds to the intended goals by ensuring confidentiality of the data managed by a DBMS regarding the three classes of hackers referred to above, by providing users with secure access (interrogation/modification) to the data to which they legally have access from any terminal connected to the Internet, and of allowing each user to share his data with other users.

The invention takes into account the following constraints:
the database can be managed by any traditional commercial DBMS,
the secure hardware support used is of current technology (for example, a conventional smart card), and
the encryption algorithms used are known.

The applications of the invention are diverse and extend to the development of mobile computer processing which corresponds to an increasing tendency among users to access their data at all times, from all places and especially from any type of terminal (PC, personal assistant, cell phone, common telephone, etc.). This assumes that the user's data are stored by a service provider ensuring round-the-clock storage and access, resistant to power failures and data secure. The data stored in this context are generally personal, for example:
medical records which contain highly confidential information and which a patient can want to access at the facility of a physician, at a pharmacy, at home, on a trip, and the like.
electronic mail which increasingly has become a work tool and obviously contains confidential information, and
the virtual environment or virtual home environment which includes private information of various natures such as bank records, schedules, address books, passwords, bookmarks, cookies, and the like, and which need to be accessible from multiple locations.

These personal applications are characterized by the following requirements:
data that must be accessible from any location and at any time,
highly confidential data because of its personal nature,
data shared by multiple human actors (e.g., medical records) or software actors (virtual home),
small volume of data, and
complex interrogations (inequality on dates or values, text search on descriptions, calculations of aggregate and grouping, etc.).

It also pertains to situations in which a user calls up services from a data storage facility for storing financial data, data associated with manufacturing processes or confidential information on its clients and suppliers. In fact, a small or medium-sized business rarely has available the set of technical and human means necessary to make secure its data against direct attacks (hacking, theft) or indirect attacks (computer viruses). Moreover, the initial motivation for a small or medium-sized business to resort to the services of a data storage facility can be a priority to ensure the durability of its data (tolerance to breakdowns), the necessity of confidentiality then being caused by the fact that the user's data are externalized. The confidentiality of the data is linked to the protection of the firm against the competition (e.g., manufacturing secrets, business strategy, etc.) and its credibility with its clients (e.g., number of bank cards). This type of application introduces the same type of requirement as the preceding with the supplementary constraint that the volume of data is potentially much larger.

The invention also pertains to a method employing a security application that interfaces between a client and a data server and which respects the following rules:
Encryption of the data to be protected that are stored on the server,
Management of the queries regarding the encrypted data and the decryption of the results, and
Management of the privileges (access rights) of each user.

This security application is self-administrable and executed on a secure hardware and software platform (SOE). Any lack of one of these rules introduces a security gap such as those identified in the preceding section. These five rules determine the technical elements of the proposed solution and basically probably the unique solution to the posed problem.

According to a preferred variant, the security means is constituted a microprocessor card.

The latest generation of smart cards comprise a monolithic chip, a 32-bit RISC processor at circa 30 MIPS, memory modules (of about 96 kb of ROM, 4 kb of RAM and 128 kb of EEPROM), an I/O component managing communications with the terminal and finally security modules protecting the card against physical attacks. The EEPROM enables storage of persistent information with a very rapid reading access time comparable to that of the RAM (60 to 100 ns/word), but very slow in writing (1 to 10 ms/word). The principal value of the smart card is its very high level of security. This security is obtained by means of the hardware security modules present in the chip and also by means of the very small size of the chips employed (<25 mm) making physical attacks very complex and expensive. The smart card is unquestionably the smallest and most secure of all “computers”. Nevertheless, the small size of the chips has an immediate impact on the storage capacity of the memory components. A microprocessor card is manifested by the following characteristics:
maximal security of the data and the code stored in the chip,
powerful processor (especially for the encryption/decryption function),
very small capacity of the RAM, and
persistent storage capacity in constant extension but very slow writing time.

According to a preferred variant of the invention, the security means is constituted of a microprocessor card. According to another variant, the security means is constituted of a key that can be connected to a port of a client's equipment. The security means furthermore preferably comprises at least one counter for the execution of statistical queries. The security means furthermore preferably comprises a register for the temporary recording of the downloaded rights of the opening of a session with the server.

According to an advantageous mode of implementation, the security means furthermore comprises a memory for recording part of the database. This solution makes it possible to avoid recording certain sensitive data on the server. The database is thus divided into two parts, with one part recorded on the server and the other recorded on the security support.

The invention also pertains to means for making secure the exchanges between a client equipment unit and a server constituted of a secure hardware support linked to the client equipment unit and comprising a microprocessor for the encryption of the attributes of the queries issued by the client equipment unit and the decryption of the responses issued by the sever, a random access memory recording intermediary results, a nonwritable memory for recording the operating system and a memory for recording the user's personalization information.

The invention also pertains to a method for the secure management of a database comprising a step of construction of a query comprising at least one attribute, comprising encryption of the attributes by a calculator integral with an individual security device linked to a client equipment unit, then interrogating a database containing data encrypted with the same encryption means as those used during the preceding step, returning a response containing the data corresponding to the attributes of the query and proceeding to the decryption of the data by the calculator of an individual security device prior to transmitting them to the host equipment.

According to a simplified variant, the translation of the queries is limited to the equality predicates to enable the execution of the executable queries directly by the server on the encrypted data.

According to a preferred variant, the translation of queries comprising inequality predicates or calculation functions comprises decomposition of the query Q in a plane Qₜ(Q_{c}(Qₛ))), interrogation of the encrypted database (3) by inequality queries from encrypted attributes, recording the results of the queries in a temporary memory by means of individual security means after decryption of the data, and recomposition of the result; wherein Qₛ symbolizes the portion of the equation that can be evaluated by the server directly on the encrypted data, Q_{c} symbolizes the complement of this query that can be evaluated by the security means after decryption and Qₜ symbolizes the portion of the query linked to the presentation and which can be transferred to the terminal without reducing the degree of security.

According to another variant the translation of the queries comprising inequality predicates or calculation functions comprises decomposition of a query in a plane Q=Qₜ(Q_{c}(Qₛ(*[Q_{c}^{P}(Qₛ^{P})]))) in which Q_{c}^{P} and Qₛ^{P} are preparation queries of interrogation of the encrypted database (3) by queries of inequities from the encrypted attributes, recording the results of the queries in a temporary memory by individual security means after decryption of the data and recomposition of the results.

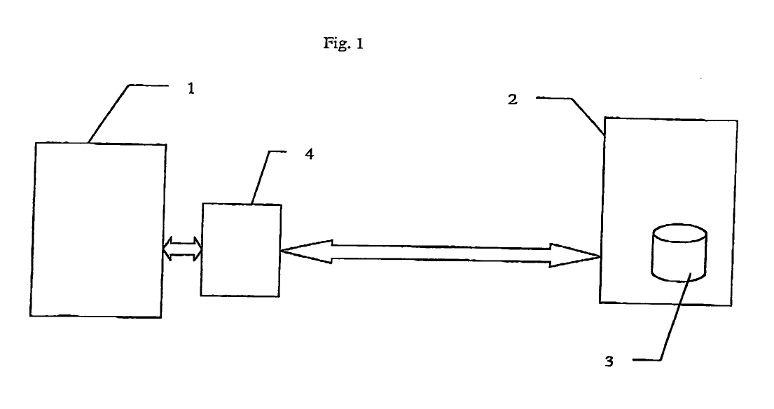

Turning now to the drawings, FIG. 1 represents a schematic view of a system according to the invention. It comprises a client equipment unit (1) which can be constituted of a microcomputer or by portable equipment such as a PDA, at cellular phone or any other equipment unit enabling consultation of a database. It is equipped with a calculator and applications for management of a database (insertion of data, consultations, modifications of the data) and for establishing a session with a server (2) to which it is connected by a telecommunication network (Internet, extranet, intranet, GSM network, etc.).

Encryption of the database is performed by the card (4) in the following manner. The card (4) intercepts all SQL schematic creation/modification queries as well as all the insertion/modification/destruction queries of tuples in the tables. The database diagram as well as the data are encrypted by the card, for example with a DES type secret key algorithm. The encryption algorithm employed is referred to below as Cipher. These queries, whose parameters are now encrypted, are then sent to the data server (2) as conventional queries. This technology therefore does not require any modification of the DBMS employed.

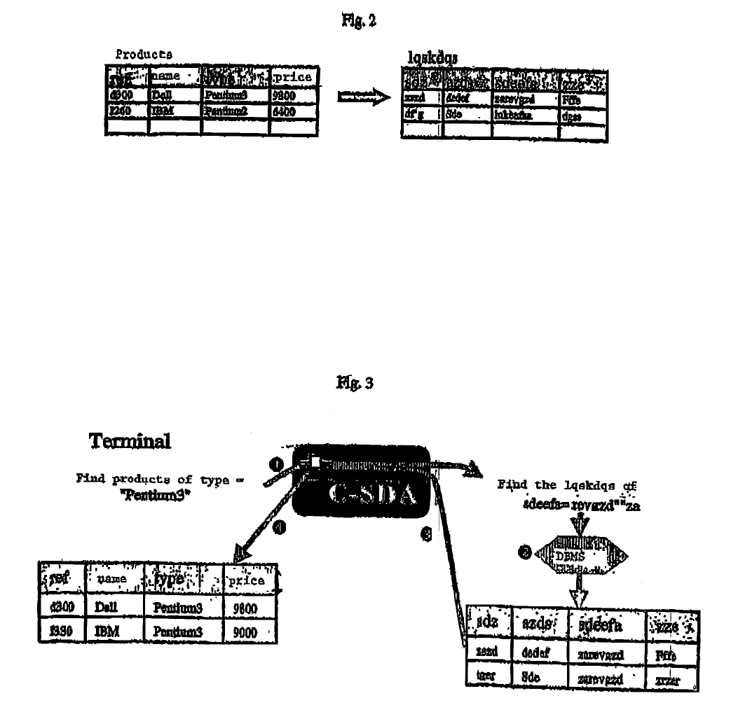

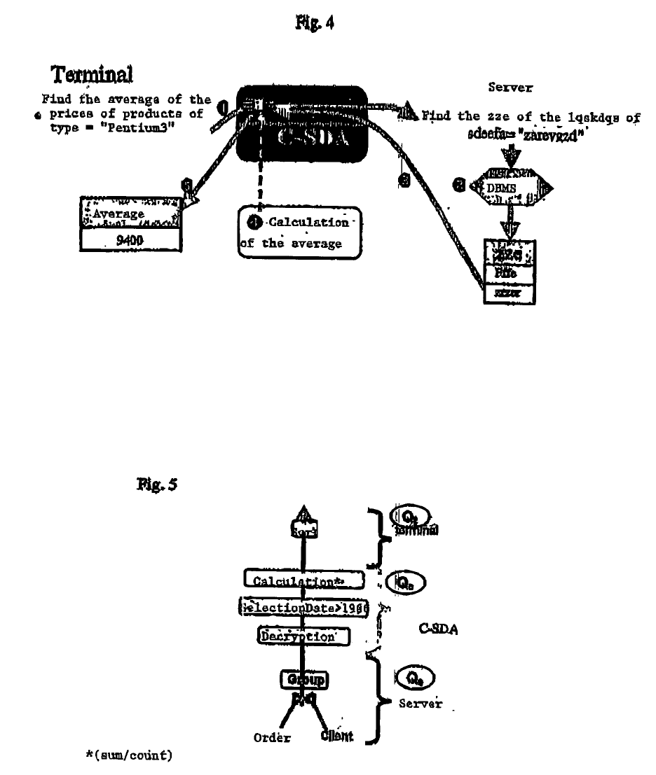

The data recorded in the server (2) are recorded in encrypted form. As illustrated in FIG. 2, the Product table (ref, name, type, price) is stored as table P(r, n, t, x) in which P=Cipher (“product), r=Cipher (ref), n=Cipher (name), etc. In this example, the integrity of the data is encrypted, with the knowledge that a partial encryption of the data can also be envisaged. Encryption is applied to the data as well as to the global information such as the name of the table and the names of the headings.

FIG. 3 represents the steps of a consultation procedure of the encrypted database. One advances to a step of preparing a query in clear on the client equipment unit (step 1). This query is transmitted by the client equipment unit to the card (4) in which the attributes of the query are encrypted prior to being transmitted to the server (2). This query is then processed in a normal manner, the search being performed on the equality criteria between the encrypted content of the query and the content encrypted with the same key recorded in the database (3) (step 2). The server does not require any adaptation, the sole difference with a traditional application coming from the fact that the search is performed with the attributes encrypted.

The response to this query is again transferred via the card (4) which performs a conversion of the content to restore the data corresponding to the query in clear (step 3). These data in clear are then retransmitted to the client equipment unit for display or recording in a local table (step 4).

This technique makes it possible to execute any query on encrypted data with only the intervention of equality predicates (attribute=value or attribute=attribute) without calculation function (aggregate, etc.). In fact, the properties of the encryption algorithms do not allow, in a general manner, evaluation of inequality predicates nor calculation functions on encrypted data. This constraint is strong because: it limits the interrogation capacities of the users, and it limits in the same manner the power of expression of the access rights.

The Resolution of a simple SQL query of the “select*from product where type=‘pentium3’” to find all pentium3 type products be is performed as follows;

1. Terminal (I): input of the query in clear,

2. Card (4): encryption and transmission of the encrypted query to the server: select from Cipher (Product) where Cipher (type)=Cipher (“pentium3”),

3. Server (2): Resolution of the query on the encrypted data (transparent for the DBMS),

4. Card (4): Decryption of the result, and

5. Terminal: Display of the result in clear.

This technique of query evaluation is possible when all of the users sharing the same data have the same encryption key. This requires two important comments:

Encryption should not in any case interfere with the access rights. With regard to the rights, it can be envisaged to encrypt the integrity of the database with a single key. Each user only has access to the data to which he has an access right, the key being known solely by the card (4) and not by each user. For example, in the case in which the security application is executed in a smart card, the key enabling decryption of the integrity of the database is present in the smart card of each user without the user having access to the key.

Multiple encryption keys can be used to increase the difficulty of breaking the key and reducing the impact. Since management of the rights is an integral part of the security mechanism, this management is not delegated to the data server.

Otherwise, the DBA would have has no difficulty in taking over the rights on the data set. Management of the rights must be ensured by the security application of the card (4). This management poses a particular problem when this application is executed in a smart card personalized for each user. In fact, the rights express a sharing of data among multiple users and these rights are dynamic (i.e., new rights can be defined and certain existing rights can be cancelled). If the smart card is responsible for the verification of the rights, it cannot on the other hand itself store the definition of these rights because of the fact of the sharing among the users. The definition of the rights is therefore stored on the server and loaded dynamically (or simply refreshed) on the card during the connection of the user to the server. The definition of the rights must be stored in encrypted form on the server to prevent any alteration that could introduce a security gap.

The power of the DBMS rights mechanism stems from the capacity to assign a right to a user on views, i.e., on virtual tables calculated by an SQL query. It then becomes possible to express the rights with a high degree of refinement, for example: give the right to a user to consult a view defined as the average of the salaries of employees aged older than 40 years working in the computer department without giving the user rights on the data enabling performance of this calculation. Thus, a view V defined by the query Q_{view} on which the user has the right D. When the user expresses a query Q(V), the rights manager verifies that this query is compatible with the right D. If yes, the query S(V) is transformed by the view manager into a query Q(Q_{view})=Q′({Ti}) in which {Ti} denotes the list of base tables on which the view V is defined. Q′ is then evaluated as a conventional query according to the previously introduced method. The consequence is that C-SDA must integrate view management in the same manner as rights management (the definition of the views is stored in an encrypted state on the server and loaded dynamically onto the card).

The description below pertains to an improved version of the invention enabling processing of all types of SQL queries. This expanded solution means that the security application participates in an active manner in the processing of the query order to evaluate the predicates that cannot be evaluated by the server. This interaction of the security application of the card (4) in the processing has two consequences. The first consequence pertains to the performance of the global execution and the second pertains to the emergence of new possibilities for reinforcing the protection of the database.

In the case of complex interrogations (inequality predicates, calculation functions, aggregate, etc.), the query Q is broken down into a part Qₛ that can be evaluated by the server on the encrypted data and its complement Q_{c} to be evaluated by the security application on the partial result after decryption. It is fundamental that Q_{c} be executed by the security application and not by the terminal because only C-SDA is executed in a secure environment. As shown above, the users rights' pertain generally to views the virtual content of which is calculated by a query. Thus, only a processing of Q_{c} by the security application, without externalization of confidential data, can ensure the level of security expected by a management of rights. For example, a user can have the right to consult the result of an aggregate calculation without having the right to consult the elementary data from which this aggregate is calculated.

C-SDA must contain filtration functions (to process the inequality predicates) and calculation functions to evaluate Q_{c}. This is the object of the second example.

The query “select Avg(price) from product where type=‘pentium3’” is performed as follows:

1. Terminal: Input of the query in clear;

2. Card: Encryption and transmission of an encrypted subquery Qₛ: select Cipher(price) from Cipher(Product) where Cipher(type)=Cipher(“pentium3”);

3. Server: Resolution of the query on the encrypted data: Result (Cipher(price1), Cipher(price2), Cipher(price3), . . . );

4. Card: Decryption of the result of Qₛ and evaluation of Q_{c} (calculation of the average); and

5. Terminal: Display of the result in clear.

It is necessary for this principle to be applicable on a smart card that evaluation of Q_{c} by the card (4) can be performed while respecting the constraints inherent in the card. These constraints impose the evaluation of Q_{c} without ever materializing temporary results because the very small RAM capacity does not allow such a materialization in volatile memory and the cost of EEPROM writing also makes this materialization impossible in stable memory. The proposed solution consists of executing the integrality of Q_{c} in pipeline mode (e.g., tuple to tuple). Although this mode of evaluation is not traditional, especially for queries involving groups and calculation of aggregates, we can show that any Q_{c} query can be evaluated in pipeline mode by following the principle of execution below:

The general form of an SQL query is:
Select list of attributes, functions,
From list of relations,
Where qualification,
Group by list of attributes,
Having qualification on aggregate function, and
Order by sort criterion,

The SQL operational semantic specifies that the result of an SQL query is equivalent to the following processing:

1. Calculation of the Cartesian product of the relations involved in the From clause;

2. Restriction to only those tuples produced in (1) satisfying the qualification of the Where clause;

3. Grouping together the tuples stemming from (2) having the same value for the specified list of attributes;

4. Calculation of the aggregate functions appearing in the Select, Having and Order by clauses;

5. Restriction solely to those groups produced in (4) satisfying the qualification of the Having clause;

6. Projection of the tuples stemming for (5) onto the list of attributes and functions of the Select clause; and

7. Sorting the tuples stemming from (6) as a function of the sort criterion specified by the Order by clause.

The server is capable executing the following steps on encrypted data, i.e., Qₛ:

1. Calculation of the Cartesian product of the relations involved in the From clause;

2. Restriction to solely those tuples produced in (1) that satisfy the equality predicates present in the qualification of the Where clause;

3. Grouping together the tuples stemming from (2s) having the same value for the specified list of attributes; and

4. Projection of the tuples stemming from (3) onto the list of attributes resulting from the union of the lists of attributes of the Select, Group by and Order by clauses as well as the list of attributes required for the evaluation of the predicates not processed in 2 of the Where clause and the predicates of the Having clause.

The security application for its part is constrained to execute in pipeline on the smart card the following steps, i.e. Q_{c}:

For each tuple t resulting from Qₛ, perform:

Verify the predicates of the Where clause not processed in 2 above;

Aggregate in a variable buffer the value of the attribute(s) of t involved in the evaluation of the aggregate function (appearing in the Select, Having and Order by clauses), doing this when t belongs to the same group as the preceding tuple (for example, calculation of the average of an attribute is performed by summing the value of the attribute of each tuple of the group. When the last tuple of the group is detected, this sum is divided by the number of tuples in the group).

5. When the end of group is detected and the aggregate functions are calculated, evaluate the qualification of the Having clause.

6. If it is selected, project the tuple stemming from (5) onto the list of attributes and functions specified in the Select clause.

In summary, as illustrated by the example of FIG. 5, the evaluation of any SQL query Q is performed in the following manner: Q=Qₜ(Q_{c}(Qₛ). This evaluation principle thoroughly respects the constraints of the card because the memory space consumed is reduced to the storage in memory of a current tuple and several buffer variables intended for the calculation of the aggregate functions.

FIG. 5 represents the ‘complex’ query execution diagram. This mode of evaluation presented above can be improved for two reasons:

Evaluation of Qₛ as presented above gives the impression that the Cartesian products are executed first (step 1). In fact, the evaluation of all or parts of 2 and 6 can be implemented before step 1 by following the traditional techniques of query optimization (replacement of the Cartesian products by joins, applications of the restrictions and projections as early as possible). Since Qₛ is transmitted to the server as a conventional SQL query, it follows the traditional optimization process.

Since the inequality predicates (restrictions, inequi-joins) cannot be evaluated directly by the server, the volume of data transferred to the card can be much greater than the volume of the final result. In the example of FIG. 5, all of the client orders are transferred to C-SDA without distinction of data. The solution to this problem is specified below.

It is necessary to evaluate the inequality predicates as early as possible to take advantage of their selectivity for simplifying the processing chain set performed on the client equipment unit, the card and the server. This requires a cooperative preprocessing between the card and the server. Let a query Q be defined as containing a predicate of the form σₐᵢ θᵥₐₗᵤₑ(T), in which σ denotes the restriction operator, θε{<, >, ≦ ≧} and aᵢ is any attribute of the table T. The optimization principle consists for the security application of sending to the server a preprocessing query Qₛ^{P}=Π_{key, ai} (T), with Π denoting the projection operator. C-SDA then executes Q_{c}^{P}=Π_{key} (σₐᵢ θᵥₐₗᵤₑ(Π_{key, decrypted (ai)}(Qₛ^{P}))) and sends the result R to the server. C-SDA then transforms the query by replacing the initial predicate σₐᵢ θᵥₐₗᵤₑ(T) with the predicate ∝ (T, R), in which ∝ denotes the semi-join operator on key. In the example of FIG. 5, this principle yields the following chain executed in pipeline on the card;
security application of the card returns the tuples from the Orders table after having performed a projection on the key attribute and the Date attribute;
security application of the card decrypts the Date attribute of these tuples, select solely the tuples with dates higher than 1996 and sends their key to the server in the form of a temporary table R; and
finally, security application of the card transforms the initial query by replacing the predicate (Q.Date>1996) with (Q.key=R.key) and sends this query to the server for exectution. The volume of data transferred is very greatly reduced. In fact, the additional expenditure in relation to a traditional execution is limited to size(Π_{key, ai} (T))+size(Π_{key}(σₐᵢ θᵥₐₗᵤₑ(T)). This principle applies in a similar manner for the inequi-joins.

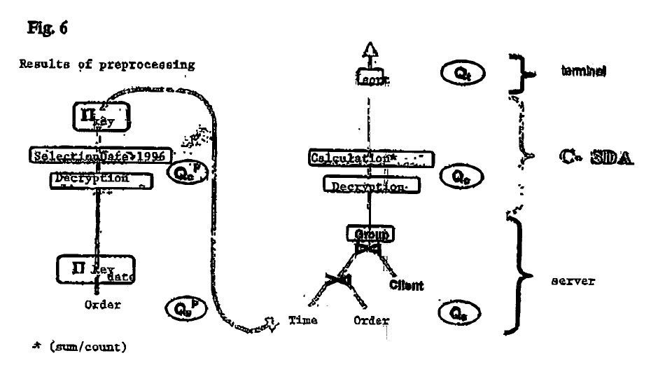

As illustrated by FIG. 6, the general principle for evaluation of a query containing inequality predicates becomes: Q=Qₜ(Q_{c}(Qₛ(*[Q_{c}^{P}(Qₛ^{P})]))), with the composition Q_{c}^{P}(Qₛ^{P}) being repeated for each inequality predicate.

The use of multiple encryption keys for the same database is a simple and effective idea for reducing the volume of data exposed in the case of breaking a key. In our context, the use of multiple keys respects the following constraint: ∀a, ∀b, a=b⇄Cipher(a)=Cipher(b). This constraint is necessary to enable the server to execute the equality predicates present in type Qₛ queries. However, this constraints does not take place if a and b are never compared, either because they are not comparable types (e.g., a whole number and a character chain), or because their comparison would be lacking in any semantic (e.g., the age of a client and the client number), or because these data belong to different users or user groups not desiring to share them. In all of these cases, it is possible to use different encryption keys according to a technique that we will refer to as vertical fragmentation encryption.

Since the data transmitted by the server to the security card are already encrypted, the opportunity to encrypt the communications is not indispensable However, this encryption is necessary to resist attacks by a user hacker. In fact, a user hacker can obtain a pair (encrypted text/clear text) by listening to the communications during the execution of an authorized query (i.e., to which he has the rights). This text pair is a noteworthy weapon for breaking the encryption key. Communications between the server and the security card must therefore be encrypted with one of the techniques of the state of the art.

Since the security card (4) participates in an active: manner in the execution of queries, it should be possible to store a part of the database considered to be very sensitive directly under the control of the card. For example, in the case in which the security application is executed in smart card, those very sensitive data can be stored in the stable memory (EEPROM) of the smart card. This approach makes these data definitively inaccessible to any type of hacker (including a user hacker). For example, if the data stored in the card correspond to the user's identification data even a hacker who managed to decrypt the entirety of the database would not know to whom the corresponding data belonged. This approach provides an incomparable degree of protection, but creates three noteworthy problems: (i) augmentation of the complexity of query evaluation; (ii) durability of the sensitive data; and (iii) optional sharing of these data among multiple users.

The security application must generate a plane of execution distributed between the two sites to evaluate a query on data of which art resides on a smart card. This task, which is complex for a smart card, can be simplified by imposing a particular manner of isolating the sensitive data. The idea consists of eliminating the sensitive data from the database stored on the server and replacing them by indices in a sensitive domain (set of data without duplicates), which sensitive domain is stored on the smart card. For example, the credit card codes of a set of clients can be stored as indices in the domain ‘credit card codes’ stored in the smart card This ‘coding’ of the sensitive data can be seen as a very particular encryption of these data, an encryption whose particular characteristic is to be definitively unbreakable with the smart card. The value of this approach is that it enable exact conservation of the same query evaluation techniques, with it being possible to perform a part of the evaluation on the server because the property ∀a, ∀b, a=b⇄Cipher(a)=Cipher(b) is preserved.

With regard to durability and sharing, we first consider the case of static sensitive data (i.e., without updating). This particular base can represent a majority of the cases in practice (e.g., the identification data of individuals or of small or medium-sized enterprises). The durability of the static data can be ensured by redundant storage of these data in a backup smart card. This backup card is only used in the case of the loss, theft or destruction of the original card. The sharing of the static sensitive data is ensured by their copy in each user's smart card. For this type of data, the security level achieved is maximized because there is no accessible copy on any servers and the content of the card is considered to be inviolable.

Now let us consider the case of dynamic data. The sharing and the durability of these data must be ensured by a server known to the set of users sharing these data. This server must conserve the history of the updates performed on the dynamic data and distribute, on request, these updates to the users having access to it. It is preferable that this server be distinct from the data server to provide protection against internal attacks (other than breaking of the encryption keys, since it then requires a coalition between internal hackers of both sites in order to implement an attack). The data stored on the sharing and durability server is encrypted. It is easier to obtain effective encryption on these historical data because no constraints relative to the execution of queries are imposed on the encryption methods. In the extreme case, it is possible to envisage a different key for each historical data item.

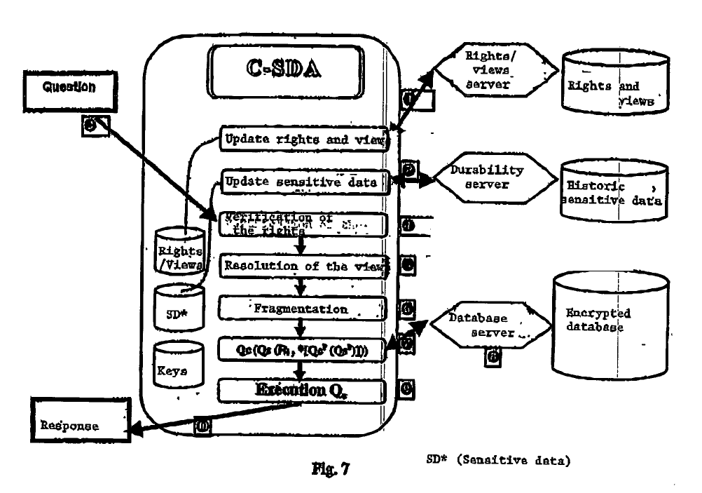

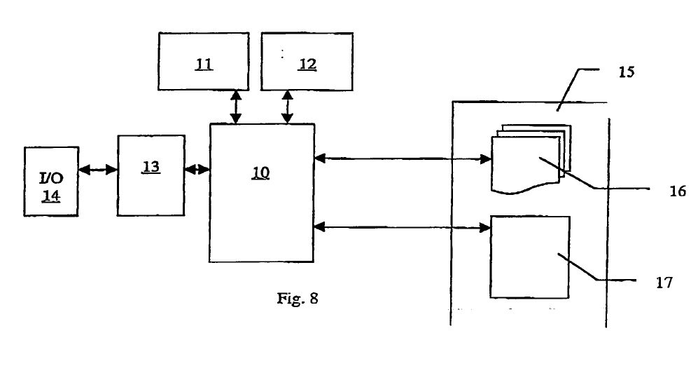

FIG. 7 summarizes a conjoint use of the set of techniques presented in the preceding section with C-SDA being executed in a smart card. The steps of execution of a user query are the following:

1. Upon connection, the security application contacts the rights and views server to update the user's list of rights and views. It decrypts them with its database of keys.

2. The security application contacts the sharing/durability server to update the dynamic sensitive data stored by the smart card.

3. The user issues a query Q.

4. The rights are verified by the security application with the database of rights and views.

5. If the query involves views, it is translated into a query Q′ pertaining to the database relations.

6. The query Q′ is transformed into a plane of execution of form Q′=Qₜ(Q_{c}(Qₛ)), optionally preceded by preparation queries (*[Q_{c}^{P}(Qₛ^{P})]) in the case of inequality predicates whose selectivity would be of value to exploit.

7. Qₛ is sent to the server which executes it on the encrypted data and sends back the resultant tuples to the security application. The result is decrypted by the security application using the database of keys.

8. The complement query Q_{c} is executed by the security application.

9. The result is optionally supplemented with the values of sensitive data (SD) during the projections.

10. The final decrypted result is sent to the terminal which executes Qₜ, i.e., the final sort if it has been requested.

FIG. 8 represents a view of the architecture of the security card (4). The electronic circuit has an input-output interface circuit (14) for the exchanges with the client equipment unit (1) and the server (2). The output of this circuit (14) is connected to a buffer memory (15).

1-19. (cancelled).

20. A secure management system for confidential databases comprising a server having at least one computer equipped with an operating system, a database storage and a communication system, at least one host computer equipment unit comprising a communication system with the server and a system for constructing queries and processing results of queries, a security system to make secure the exchanges between the client equipment unit and the server, wherein the security system comprises a secure hardware support connected to the client equipment unit and a microprocessor for encryption of attributes of the queries issued by the client equipment unit and decryption of responses issued by the server, a memory for recording intermediary results, a memory for recording the operating system and wherein the server records encrypted data,

21. The secure database management system according to claim 20, wherein the security system is a microprocessor card:

22. The secure database management system according to claim 20, where the security system is a key that can be attached on a port of the client equipment unit.

23. The secure database management system according to claim 20, wherein the security system further comprises a memory for recording a user's personalization information.

24. The secure database management system according to claim 20, wherein the security system further comprises a counter for execution of statistical queries.

25. The secure database management system according to claim 20, wherein the security system further comprises a register for management of rights downloaded upon initiation of a session with the server.

26. The secure database management system according to claim 20, wherein the security system further comprises a memory for recording of a part of the database.

27. A method for secure management of a database comprising:
construction of a query comprising at least one attribute,
encrypting attributes by a calculator integral with an individual security device linked to a client equipment unit,
interrogating a database containing data encrypted with a similar encryption system as those used during the preceding step,
returning a response containing data corresponding to attributes of the query, and
decryption of the data by the calculator of an individual security device prior to transmitting them to host equipment.

28. The method for secure management of a database according to claim 27, wherein encryption of the attributes of the query and decryption of the response is performed by a security application operated by a microprocessor card.

29. The method for secure management of a database according to claim 27, wherein encryption of the attributes of the query and decryption of the response is performed by a security application operated by a key that can be attached to a port of a client equipment unit.

30. The method for secure management of a database according to claim 27, wherein encryption of the attributes of the query and decryption of the response is performed according to a secret key algorithm.

31. The method for secure management of a database according to claim 27, wherein translation of queries is limited to equality predicates to allow execution of executable queries directly by the server on encrypted data.

32. The method for secure management of a database according to claim 27, wherein translation of queries comprising inequality predicates or calculation functions comprises decomposition of query Q in a plane Qₜ(Q_{c}(Qₛ))), of interrogation of the encrypted database by inequality queries from encrypted attributes, recording results of the queries in a temporary memory with an individual security system after decryption of the data, and recomposition of the result.

33. The method for secure management of a database according to claim 27, wherein translation of the queries comprising inequality predicates or calculation functions comprises decomposition of a query in a plane Q=Qₜ(Q_{c}(Qₛ(*[Q_{c}^{P}(Qₛ^{P})]))) in which Q_{c}^{P} and Qₛ^{P} are preparation queries of interrogation of the encrypted database by queries of inequalities from the encrypted attributes, recording the results of the queries in a temporary memory with a security system after decryption of the data and recomposition of the results.

34. The method for secure management of a database according to claim 27, wherein a part of the database is recorded in a memory of the individual security device.

35. The method for secure management of a database according to claim 27, wherein resolution of an SQL query is implemented by performing inputting a query in clear on the client equipment unit, it encryption by the security system of the attribute of the query and transmission of the encrypted query to a server, resolution of the query on the encrypted data by the server, decryption of the result on the security system and reconstruction of the result in clear on the client equipment unit.

36. The method for secure management of a database according to claim 27, wherein resolution of an SQL query comprising inequality predicates or calculation functions is implemented by performing inputting a query in clear on the client equipment unit, encryption by the security system and transmission to a server of an encrypted subquery Qₛ containing solely equality predicates, resolution of the query on the encrypted data by the server, decryption of the result of Qₛ and evaluation of Q_{c} and reconstruction of die response to the initial query by the security system.

37. The method for secure management of a database according to claim 27, finer comprising a cooperative preprocessing between the security system and a server, comprising, for a query Q containing a predicate of the from σₐᵢ θᵥₐₗᵤₑ(T), in which σ denotes a restriction operator, θε{<, >, ≦≧} and aᵢ is any attribute of a table T, of sending to a sever a preprocessing query Q_{c}^{P}=Π_{key, ai} (T), with Π denoting a projection operator, executing on the security system function Q_{c}^{P}=Π_{key} (σₐᵢ θᵥₐₗᵤₑ(Π_{key decrypted (ai)}(Qₛ^{P}))) and sending a result R to the server, the security system then transforming the query by replacing the initial predicate σₐᵢ θᵥₐₗᵤₑ(T) with the predicate ∝ (T, R), in which ∝ denotes semi-join operator on key.

38. The method for secure management of a database according to claim 27, further comprising:
upon connection, the security system contacts a rights and views server to update the user's list of rights and views and decrypts them with database of keys, the security system contacts a sharing/durability server to update dynamic sensitive data stored by the security system; the user issues a query Q, rights are verified by the security system with the database of rights and views. If the query involves views, translating the query into a query Q′ pertaining to the database relations, transforming the query Q′ into a plane of execution of for Q′=Qₜ(Q_{c}(Qₛ)), optionally preceded by preparation queries (*[Q_{c}^{P} (Qₛ^{P})]) in the case of inequality predicates whose selectivity is of value to exploit, sending Qₛ to the server which executes it on encrypted data and sends back resultant tuples to the security system, decrypted the result by the security system using the database of keys, executing a complement query Q_{c} by the security system, optionally supplementing the result with values of sensitive data (SD) during projections, and sending a final decrypted result to the terminal which executes Qₜ, if it has been requested.
